(19) United States
(12) Patent Application Publication
(10) Pub. No.: US 2025/0030997 A1
(43) Pub. Date: Jan. 23, 2025

(54) SPEAKER MEGAPHONE

(71) Applicant: Marc Linton, Alamogordo, NM (US)

(72) Inventor: Marc Linton, Alamogordo, NM (US)

(21) Appl. No.: 18/774,517

(22) Filed: Jul. 16, 2024

Related U.S. Application Data
(60) Provisional application No. 63/528,365, filed on Jul. 22, 2023.

(51) Int. Cl. H04R 27/04; H04R 1/02; H04R 1/24; H04R 1/34

(52) U.S. Cl. CPC H04R 27/04; H04R 1/025; H04R 1/24; H04R 1/345

(57) ABSTRACT

A speaker assembly includes a horn including a surface defining a horn volume and a speaker driver including a diaphragm disposed in the horn volume and spaced apart from the surface by a distance. The speaker driver is oriented to direct sound toward the surface.

### CROSS-REFERENCE TO RELATED APPLICATIONS

This application claims the benefit and priority of U.S. Provisional Application No. 63/528,365 filed on 22 Jul. 2023 and titled “Physical Speaker With Megaphone Effect,” the entirety of which is incorporated herein by reference.

### FIELD

The present disclosure relates generally to audio devices. More particularly, the present disclosure relates to speaker megaphone systems, assemblies, and devices.

### BACKGROUND

Live sound productions, such as live music, concerts, and other events, provide a unique auditory experience. The characteristics and authentic feel of live audio has yet to be fully realized using current speakers and audio technology. Attempts have been made to recreate live audio using speaker assemblies and megaphone devices, electronic modifications, and other technologies, but current speakers and audio systems still fall short. What is needed in the art are speakers and speaker systems that more closely mimic live audio experiences for users.

### SUMMARY

In at least one example of the present disclosure, a speaker assembly includes a horn including a surface defining a horn volume and a speaker driver including a diaphragm disposed in the horn volume and spaced apart from the surface by a distance. In such an example, the speaker driver is oriented to direct sound toward the surface.

In one example, the horn volume is substantially symmetrical about a central axis of the horn volume, the diaphragm defines a major plane disposed substantially perpendicular to the central axis, the speaker driver is configured to direct sound in a first direction, and the horn is configured to direct the sound in a second direction opposite the first direction. In one example, the diaphragm is aligned substantially with a central axis of the horn volume. In one example, the speaker driver is coupled to the horn via a spacer defining the distance. In one example, the distance is between about 0.25-inches and about 1-inch. In one example, the distance is between about 0.25-inches and about 0.75-inches. In one example, the surface defines a dimple protrusion aligned with a central axis of the horn volume and extending toward the diaphragm. In one example, the speaker assembly further includes a second horn spaced apart from the first horn and defining an aperture and a second speaker driver including a second diaphragm disposed in the aperture and oriented to direct sound between the first horn and the second horn. In one example, the first horn is at least partially disposed in a second horn volume of the second horn. In one example, at least a portion of the surface is concave. In one example, the horn volume is at least partially semi-spherical.

In at least one example of the present disclosure, a megaphone assembly includes a first horn including a first surface defining a first horn volume, a first speaker driver including a first diaphragm disposed in the first horn volume, the first diaphragm being spaced apart from the first surface and oriented to direct first sound toward the first surface, a second horn including a second surface defining a second horn volume and spaced apart from the first horn such that the first horn is at least partially disposed within the second horn volume, the second horn defining an aperture, and a second speaker driver including a second diaphragm disposed at or near the aperture and oriented to direct second sound between the first horn and the second surface.

In one example, the first speaker driver is oriented to direct sound in a first direction and the second speaker driver is oriented to direct sound in a second direction opposite the first direction. In one example, the first speaker driver is configured to produce the first sound in a first frequency range and the second speaker driver is configured to produce the second sound in a second frequency range lower than the first frequency range. In one example, the first diaphragm is smaller than the second diaphragm. In one example, the first horn is disposed between the first speaker driver and the second horn.

In at least one example of the present disclosure, a device includes a horn including a surface defining a horn volume having an axis of symmetry and a speaker driver including a diaphragm disposed in the horn volume and centrally aligned with the axis of symmetry, the diaphragm being spaced apart from the surface by a distance of between about 0.25-inches and about 1.5-inches. In such an example, the speaker driver is oriented to direct sound toward the surface in a first direction and the surface is configured to redirect the sound in a second direction opposite the first direction.

In one example, the device can further include a spacer disposed between the speaker driver and the surface to define the distance. In one example, the horn is a first horn, the surface is a first surface, the horn volume is a first horn volume, the speaker driver is a first speaker driver, the diaphragm is a first diaphragm, and the sound is a first sound and the device further includes a second horn disposed in the first horn volume, the second horn including a second surface defining a second horn volume and a second speaker driver including a second diaphragm disposed in the second horn volume, the second diaphragm oriented to direct second sound toward the second surface in the first direction. In one example, the device further includes a third horn including a third surface defining a third horn volume and spaced apart from the first horn such that the first horn is at least partially disposed within the third horn volume and the first horn is disposed between the second horn and the third horn, the third horn defining an aperture and a third speaker driver including a third diaphragm disposed at or near the aperture and oriented to direct third sound in the second direction and between the first horn and the third surface.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective view of an example of a speaker megaphone assembly;

FIG. 1B shows a cross-sectional view thereof;

FIG. 2A shows a perspective view of another example of a speaker megaphone assembly;

FIG. 2B shows a cross-sectional view thereof;

FIG. 3A shows a perspective view of another example of a speaker megaphone assembly;

FIG. 3B shows a cross-sectional view thereof;

FIG. 4A shows a perspective view of another example of a speaker megaphone assembly;

FIG. 4B shows a cross-sectional view thereof; and

FIG. 5 shows a cross-sectional view of another example of a speaker megaphone assembly.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure relates to audio technology. In particular, the present disclosure relates to speaker megaphone assemblies and systems. While current audio speaker systems and technologies fail to fully imitate the feel and characteristics of live audio, the systems, devices, and assemblies of the present disclosure can achieve high quality, authentic, and live-feeling audio transmission. In at least one example, the speaker megaphone assemblies described herein are arranged such that sound waves output by a speaker are compressed and pressurized before being redirected by an audio horn to transmit the pressurized sound in the intended direction.

For example, in at least one speaker megaphone assembly described herein, a speaker driver, including an audio diaphragm, is disposed within a curvilinear horn and oriented to direct sound at an interior surface of the horn. The diaphragm can be spaced apart from the interior surface at a distance that results in the compression and thus pressurization of the sound waves between the interior surface of the horn and the diaphragm. The distance can be such that the sound is pressurized but not distorted. Once pressurized, the sound is guided along the curvilinear interior surface of the horn in an opposite direction out from the horn. The resulting characteristics and quality of sound mimic live audio production. Using such systems with speakers inside and facing audio horns enables listeners to enjoy live-like sound quality and audio experiences.

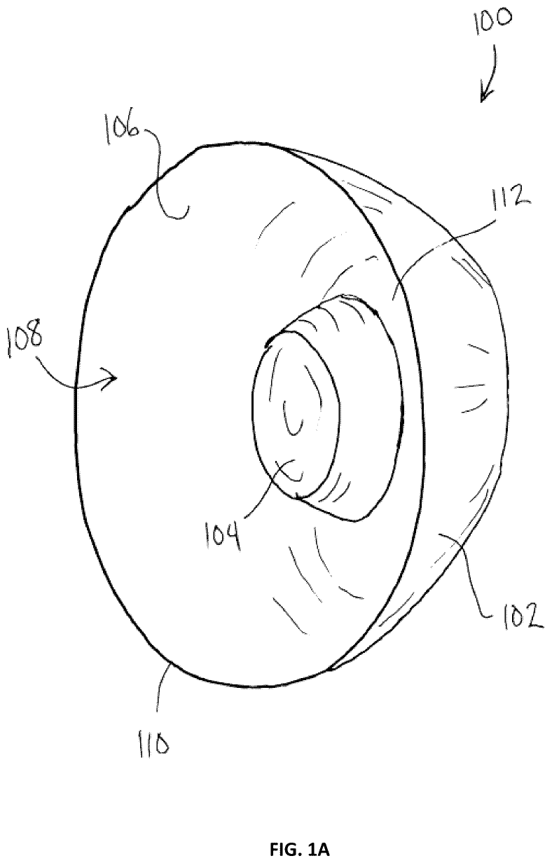

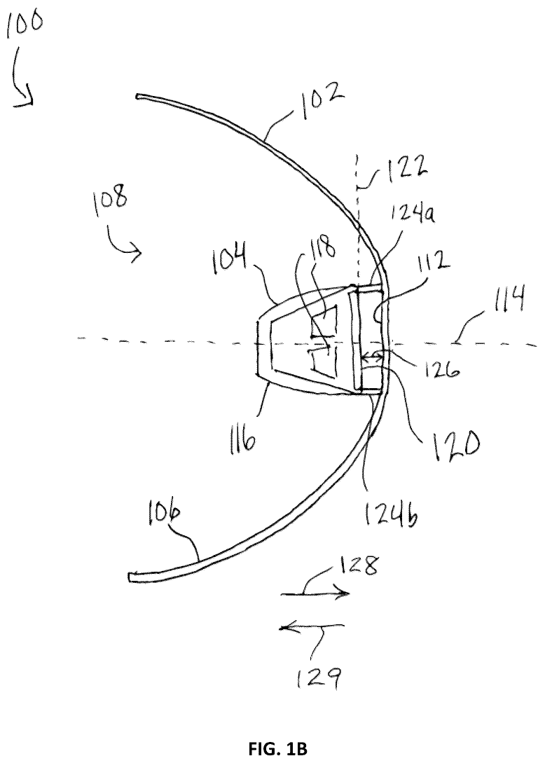

These and other embodiments are discussed below with reference to FIGS. 1A-5. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A and 1B show a perspective and cross-sectional view, respectively, of an example of a speaker assembly 100 including a horn 102 and a speaker driver 104. The horn 102 can include a dish-shaped surface, including a dish-shaped interior surface 106 defining a horn volume 108. The horn 102 can include an outer edge 110 defining or lying within a plane bounding the horn volume 108. In at least one example, the interior surface 106 and thus the horn volume 108 is at least partially semi-spherical. In one example, the horn volume 108 is at least partially curvilinear. In at least one example, a terminal portion 112 of the interior surface 106 can be flat or planar, for example a terminal end or portion 112 of the interior surface 106 of the horn 108 can be substantially planar. In other examples, the terminal end portion 112 of the interior surface 106 is semi-spherical or otherwise curvilinear in shape. In at least one example, the interior surface 106 is concave.

The horn 102 can be formed of a variety of materials or combinations thereof, including metals such as stainless steel, aluminum, plastics and other polymers, natural materials such as wood, or synthetic materials such as carbon fiber, metal alloys, and the like.

In at least one example, the speaker assembly or driver 104 can include a diagram (not shown in FIG. 1A but shown in the cross-sectional view of FIG. 1B) disposed within the horn volume 108 and space apart from the interior surface 106 by a distance. The speaker driver 104 can be oriented to direct sound toward the interior surface 106 of the horn 102. In this way, the speaker driver 104 is configured to direct sound toward the interior surface 106 of the horn 102 and the curvilinear surface 106 is configured to redirect the sound in the opposite direction out of the horn 102.

FIG. 1B shows a cross-sectional view of the speaker assembly 100 shown in FIG. 1A. In at least one example, the horn 102 includes the interior surface 106, which defines the horn volume 108 having an axis of symmetry 114. The speaker driver 104 can include a housing 116, various speaker driver components 118, and a diaphragm 120 arranged generally centrally with the axis of symmetry 114 and defining a major diaphragm plane 122 perpendicular to the axis of symmetry 114. In at least one example, the speaker driver 104 can be secured to the horn 102 within the horn volume 108 via one or more spacers 124a, 124b to define a distance 126 resulting in a space or volume between the diaphragm 120 and the terminal end portion 112 of the interior surface 106. As noted above, in one example, the terminal end portion 112 of the interior surface 106 can be planar. In another example, the terminal end portion 112 of the interior surface 106 can be semi-spherical or otherwise curvilinear.

In examples where the terminal end portion 112 of the interior surface 106 is substantially planar, the diaphragm 120 can be separated from the interior surface 106 at the distance 126 at all points of the diaphragm. In other examples, at the least the central portion of the diaphragm 120 aligned with the axis of symmetry 114 can be spaced apart by the distance 126. In such an example, the speaker driver 104 is oriented to direct sound toward the interior surface 106 in a first direction 128 and the surface 106 is configured to redirect the sound in a second direction 129 opposite the first direction. In at least one example, the horn 102 is substantially symmetrical about the central axis of symmetry 114 of the horn volume 108.

In order to achieve a realistic, live sound generations (e.g., live music) quality to sound generated by the speaker driver 104, the diaphragm 120 directs sound toward the interior surface 106 as shown within the volume defined by the space/distance 126. The sound is compressed and pressurized within that volume in the distance 126 and then redirected in the other direction along the interior surface 106 and in the horn volume 108 to be directed based on the orientation of the horn 102. This compression and thus increased pressure of sound within the space/distance 126 and subsequent direction from the interior surface 106 creates a high-quality, live experience for a user hearing the sound from the speaker assembly 100. In order to achieve the desired pressure, re-direction, and diffusion of the sound, the space/distance 126 is intentionally set to achieve the desired audio effects and quality discussed herein. In order to achieve such audio qualities, in at least one example, the distance 126 can be between about 0.25-inches and about 1.5-inches, for example between about 0.25-inches and about 1-inch, or for example between about 0.25-inches and about 0.75-inches.

Any of the features, components, and/or parts, including the arrangements and configurations thereof shown in FIGS. 1A-1B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1A-1B.

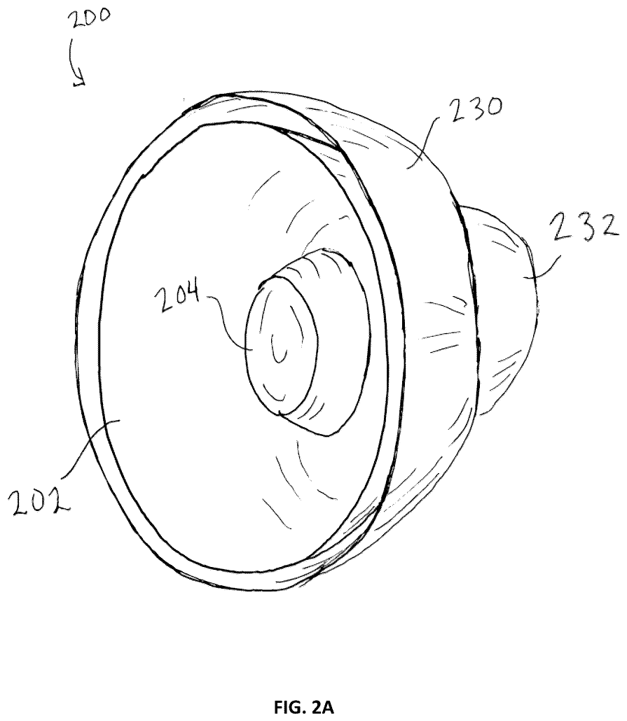

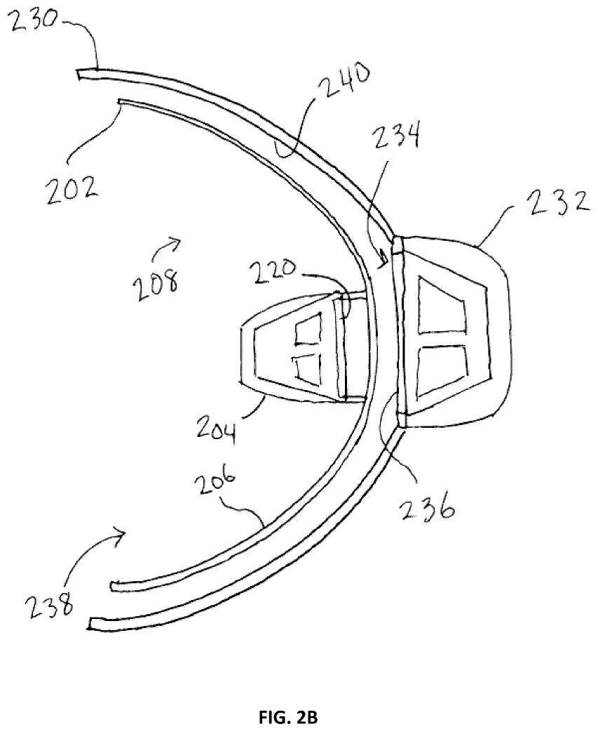

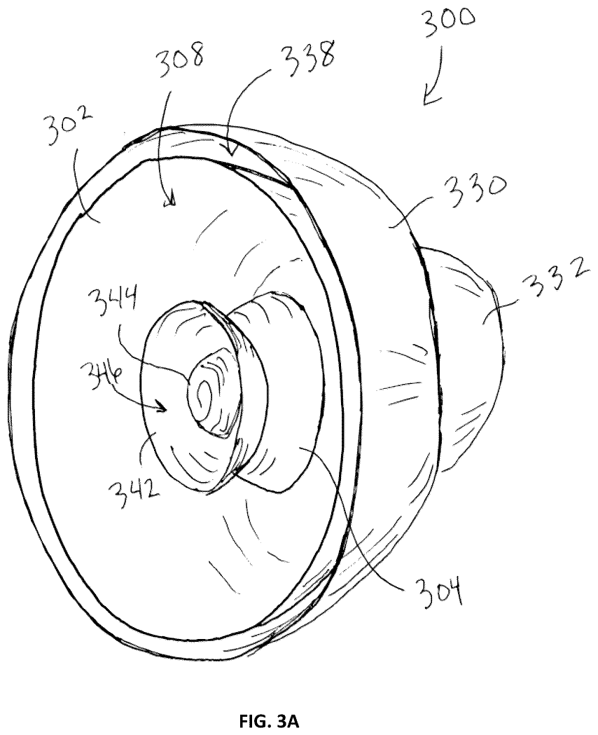

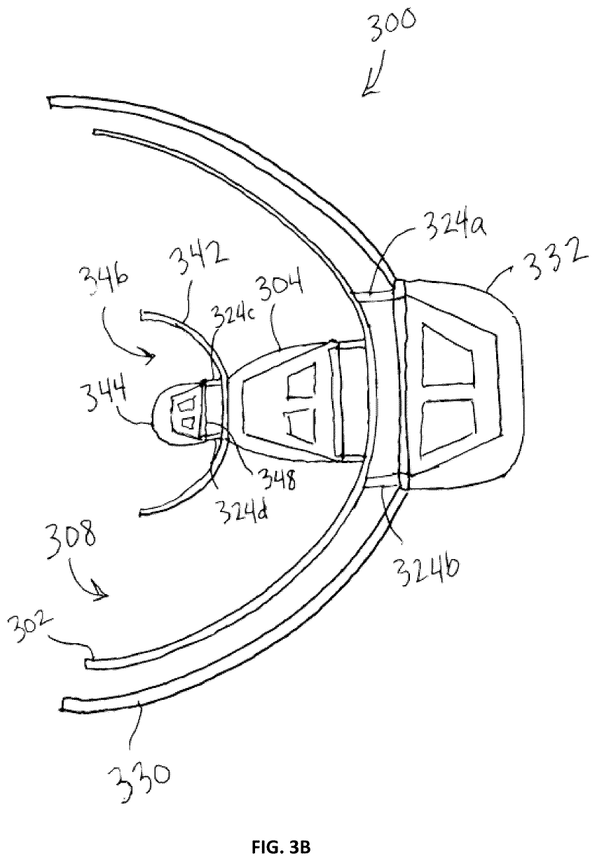

FIGS. 2A and 2B show a perspective and cross-sectional view, respectively, of another example of a speaker assembly 200. In one example, the speaker assembly 200 can include a megaphone assembly for amplifying sound and improving sound quality as discussed herein. In at least one example, the speaker assembly 200 can include a first horn 202 with a first speaker driver 204, similar to those shown in FIGS. 1A and 1B. The speaker assembly 200 can further include a second horn 230 spaced apart from the first horn 202 and defining an aperture 234 in or at which a second speaker driver 232 is disposed. In particular, the speaker driver 232 can be disposed such that the diaphragm 236 thereof is configured to direct sound through the aperture 234 and in the space/volume defined between the first horn 202 and the second horn 230. In at least one example, the second horn 230 can be secured to and spaced apart from the first horn 202 via one or more spacers (not shown in the cross-sectional viewing plane of FIG. 2B but illustrated as spacers 324a and 324b in FIG. 3B) to define the distance and thus volume between the first and second horns 202, 230.

The first horn 202 can define a first horn volume 208 and the second horn 230 can define a second horn volume 238. In at least one example, the first horn 202 is at least partially disposed within the second horn volume 238. In such an example, the first speaker driver 204 includes a first diaphragm 220 within the first horn volume 208, which is oriented and configured to direct sound toward the interior surface 206 defining the first horn volume 208. The second diaphragm 236 (e.g., the diaphragm 236 of the second speaker driver 232) can be oriented and configured to direct a second sound through the aperture 234 and into a volume defined between the second horn 230 and the first horn 202, for example between a surface 240 of the second horn 230 defining the second horn volume 238 and the first horn 202. In such an example, the first horn 202 can be disposed between the first speaker driver 204 and the second horn 230.

In such an example, the first speaker driver 204 and the second speaker driver 232 can be oriented to direct sound in opposite directions, for example direction pointing at one another, while sound from the first speaker driver 204 is redirected to exit the first horn volume 208 in the same direction as sound from the second speaker driver 232 is directed out from the second horn volume 238 between the first horn 202 and the second horn 230. In this way, a first range of frequencies output by the first speaker driver 204 can be combined with the output of a second range of frequencies from the second speaker driver 232 in a compact architecture and assembly. This arrangement can compress and diffuse sound in the same was as described above, based on the orientation and spacing of the horns 202, 230 and speaker drivers 232, 204, with the sound from the first speaker driver 204 initially being compressed and pressurized between the diaphragm 220 and the first horn 202 and the sound from the second speaker driver 232 being compressed and guided out between the first and second horns 202, 230.

In at least one example, the frequency range of the first speaker driver 204 can be less (e.g., include smaller frequencies) than the frequency range of the second speaker driver 232. In such an example, the first diaphragm 220 can be smaller than the second diaphragm 236. This example illustrated in FIGS. 2A and 2B can be a double-nested configuration of horns and speaker drivers to accomplish a compact package of speakers having different frequencies and sizes in order to improve the quality of sound in a wide range of frequencies. For example, the frequency range and size of the first speaker driver 204 can be less than the frequency range and size of the second speaker driver 232.

Any of the features, components, and/or parts, including the arrangements and configurations thereof shown in FIGS. 2A-2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2A-2B.

FIGS. 3A and 3B show a perspective and cross-sectional view, respectively, of another example of a speaker assembly, including a first horn 302 and a first speaker driver 304 disposed in the first horn volume 308, a second horn 330 defining a second horn volume 338 in which the first horn 302 is at least partially disposed. The assembly 300 can also include a second speaker driver 332 similar to the second speaker driver 232 illustrated in FIGS. 2A and 2B. In the illustrated example of FIGS. 2A and 2B, the assembly 300 can further include a third horn 342 and a third speaker driver 344 disposed at least partially within the third horn volume 346 defined by the third horn 342.

In the illustrated example, the third speaker driver 344 can include a third diaphragm 348 disposed within the third horn volume 346 and space apart from an interior surface thereof, similar to the first speaker driver 304 spaced apart from the first horn 302 (and similar to the diaphragm 120 spaced apart from the interior surface 106 of the horn 102 shown in FIGS. 1A and 1B). In this way, the third speaker driver 344 can be oriented and configured to direct sound toward the third horn 342 to increase sound pressure and cause diffusion in such a way as to increase the live characteristics and quality of the output sound. This example illustrated in FIG. 3B can be a triple-nested configuration of horns and speaker drivers to accomplish a compact package of speakers having different frequencies and sizes in order to improve the quality of sound in a wide range of frequencies. For example, the frequency range and size of the third speaker driver 344 can be less than the frequency range and size of the first speaker driver 204, which in turn can be smaller and higher-frequency than the second speaker driver 232.

As noted above with reference to other examples, the distance between speaker diaphragms and interior horn surface to which the speakers direct sound can affect the quality and characteristics of the output sound. Along these lines, the third speaker driver 344 can be secured to and spaced apart from the third horn 342 via one or more spacers 324e, 324f and the second horn 330 can be spaced apart from the first horn 302 via one or more spacers 324a, 324b as shown in the cross-sectional view of FIG. 2B.

Any of the features, components, and/or parts, including the arrangements and configurations thereof shown in FIGS. 3A-3B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 3A-3B.

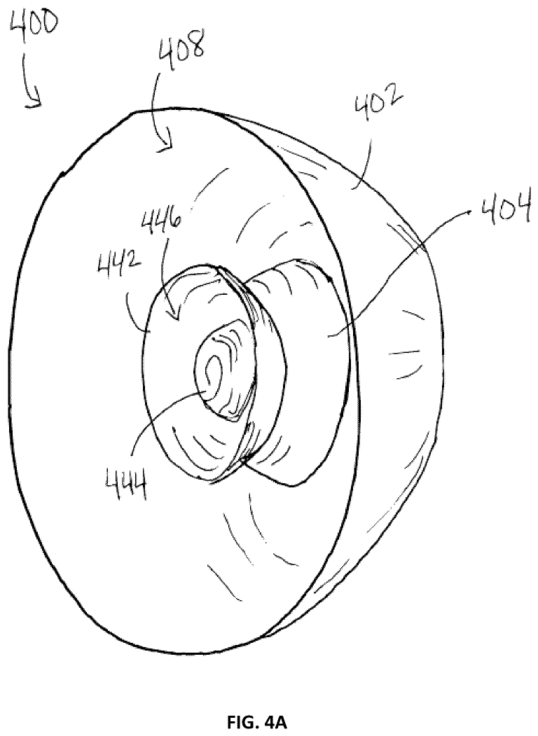

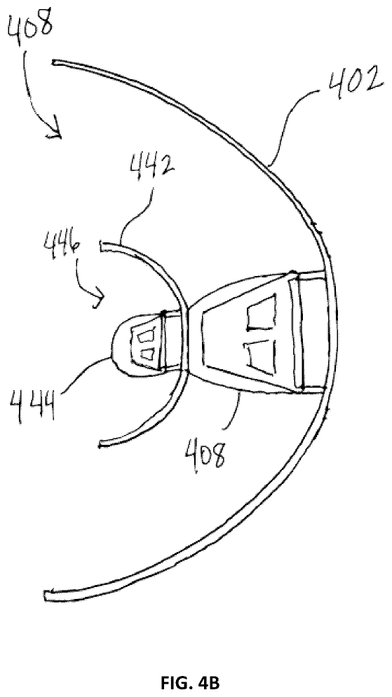

FIGS. 4A and 4B shows a perspective and cross-sectional view, respectively, of another example of a speaker megaphone assembly 400, including first and second horns 402, 442 defining first and second horn volumes 408, 446, respectively. A first speaker driver 404 can be disposed within the first horn volume 408 similar to the first speaker driver 304 disposed in the first horn 308 illustrated in FIGS. 3A and 3B and a second speaker driver 444 can be disposed within the second horn volume 446 similar to the third speaker driver 344 disposed in the third horn volume 346 shown in FIGS. 3A and 3B. In this compact arrangement, the second speaker driver 444 can be smaller and produce higher frequencies than the first speaker driver 404 such that the assembly can output a wide range of frequencies at the quality and characteristics noted in other examples. The example shown in FIGS. 4A and 4B can be similar to the assembly 300 shown in FIGS. 3A and 3B but without the second horn 330 and the second speaker driver 332 shown and described above.

Any of the features, components, and/or parts, including the arrangements and configurations thereof shown in FIGS. 4A-4B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4B.

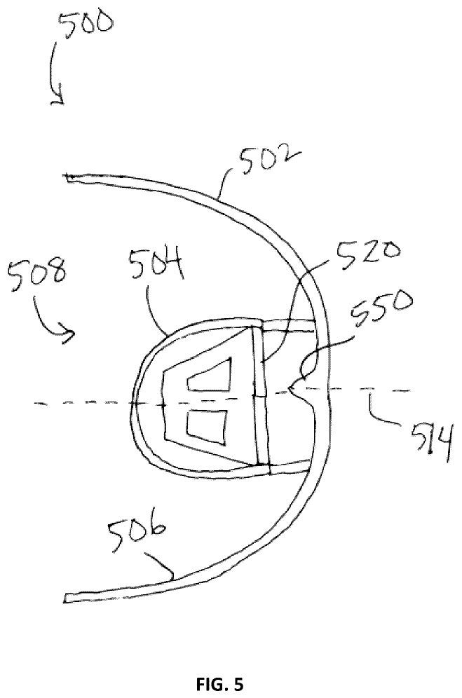

FIG. 5 shows another example of a speaker megaphone assembly 500 including a horn 502 including an axis of symmetry 514 and an interior surface 506 defining a horn volume 508. A speaker driver 504 can include a diaphragm 520 disposed within the horn volume 508 and generally aligned with and perpendicular to the axis 514. The speaker driver 504 and diaphragm 520 thereof can be situated similarly to the speaker driver 104 and horn 102 shown in FIGS. 1A and 1B and described above, in order to achieve the same audio quality enhancements and characteristics noted herein.

In at least one example, as shown in FIG. 5, the interior surface 506 of the horn 502 can include or define a dimple 550 or other raised protrusion extending toward the diaphragm 520. In at least one example, the dimple 550 can be generally aligned with the axis 514 and thus with the diaphragm 520. The dimple 550 can provide a surface central to the audio wave output of the diaphragm 520 which splits and smoothly directs the sound waves onto the terminal end portion 512 of the interior surface 506 of the horn 502. This smooth direction and transition of sound waves from the first direction out from the diaphragm, to the interior surface 506 to be redirected out from the horn 502, can further enhance the audio quality and characteristics of the assembly 500 and reduce unwanted interferences or distortion of sound exiting the assembly 500.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A speaker assembly, comprising:
a horn including a surface defining a horn volume; and
a speaker driver comprising a diaphragm disposed in the horn volume and spaced apart from the surface by a distance;
wherein the speaker driver is oriented to direct sound toward the surface.

2. The speaker assembly of claim 1, wherein:
the horn volume is substantially symmetrical about a central axis of the horn volume;
the diaphragm defines a major plane disposed substantially perpendicular to the central axis;
the speaker driver is configured to direct sound in a first direction; and
the horn is configured to direct the sound in a second direction opposite the first direction.

3. The speaker assembly of claim 1, wherein the diaphragm is aligned substantially with a central axis of the horn volume.

4. The speaker assembly of claim 1, wherein the speaker driver is coupled to the horn via a spacer defining the distance.

5. The speaker assembly of claim 1, wherein the distance is between about 0.25-inches and about 1-inch.

6. The speaker assembly of claim 5, wherein the distance is between about 0.25-inches and about 0.75-inches.

7. The speaker assembly of claim 1, wherein the surface defines a dimple protrusion aligned with a central axis of the horn volume and extending toward the diaphragm.

8. The speaker assembly of claim 1, wherein:
the horn is a first horn, the speaker driver is a first speaker driver, and the diaphragm is a first diaphragm; and
the speaker assembly further comprises:
a second horn spaced apart from the first horn and defining an aperture; and
a second speaker driver including a second diaphragm disposed in the aperture and oriented to direct sound between the first horn and the second horn.

9. The speaker assembly of claim 8, wherein:
the horn volume is a first horn volume;
the second horn defines a second horn volume; and
the first horn is at least partially disposed within the second horn volume.

10. The speaker assembly of claim 1, wherein at least a portion of the surface is concave.

11. The speaker assembly of claim 10, wherein the horn volume is at least partially semi-spherical.

12. A megaphone assembly, comprising:
a first horn including a first surface defining a first horn volume;
a first speaker driver comprising a first diaphragm disposed in the first horn volume, the first diaphragm being spaced apart from the first surface and oriented to direct first sound toward the first surface;
a second horn including a second surface defining a second horn volume and spaced apart from the first horn such that the first horn is at least partially disposed within the second horn volume, the second horn defining an aperture; and
a second speaker driver comprising a second diaphragm disposed at or near the aperture and oriented to direct second sound between the first horn and the second surface.

13. The megaphone assembly of claim 12, wherein:
the first speaker driver is oriented to direct first sound in a first direction; and
the second speaker driver is oriented to direct second sound in a second direction opposite the first direction.

14. The megaphone assembly of claim 13, wherein:
the first speaker driver is configured to produce the first sound in a first frequency range; and
the second speaker driver is configured to produce the second sound in a second frequency range lower than the first frequency range.

15. The megaphone assembly of claim 12, wherein the first diaphragm is smaller than the second diaphragm.

16. The megaphone assembly of claim 12, wherein the first horn is disposed between the first speaker driver and the second horn.

17. A device, comprising:
a horn including a surface defining a horn volume having an axis of symmetry; and
a speaker driver comprising a diaphragm disposed in the horn volume and centrally aligned with the axis of symmetry, the diaphragm being spaced apart from the surface by a distance of between about 0.25-inches and about 1.5-inches;
wherein the speaker driver is oriented to direct sound toward the surface in a first direction and the surface is configured to redirect the sound in a second direction opposite the first direction.

18. The device of claim 17, further comprising a spacer disposed between the speaker driver and the surface to define the distance.

19. The device of claim 17, wherein:
the horn is a first horn, the surface is a first surface, the horn volume is a first horn volume, the speaker driver is a first speaker driver, the diaphragm is a first diaphragm, and the sound is a first sound; and
the device further comprises:
a second horn disposed in the first horn volume, the second horn including a second surface defining a second horn volume; and
a second speaker driver comprising a second diaphragm disposed in the second horn volume, the second diaphragm oriented to direct second sound toward the second surface in the first direction.

20. The device of claim 19, further comprising:
a third horn including a third surface defining a third horn volume and spaced apart from the first horn such that the first horn is at least partially disposed within the third horn volume and the first horn is disposed between the second horn and the third horn, the third horn defining an aperture; and
a third speaker driver comprising a third diaphragm disposed at or near the aperture and oriented to direct third sound in the second direction and between the first horn and the third surface.
